(19) United States
(12) Patent Application Publication
(10) Pub. No.: US 2007/0115109 A1
(43) Pub. Date: May 24, 2007

(54) SECURITY SYSTEM AND METHOD FOR MASS TRANSIT VEHICLES

(75) Inventors: David L. Turney, DALLAS, TX (US); Floyd James Diaz, DURHAM, NC (US); Rob R. Taylor, CARY, NC (US); Johnny Earl Simpson, RALEIGH, NC (US); James Dennis Kennedy, RALEIGH, NC (US)

Correspondence Address: HOWISON & ARNOTT, L.L.P, P.O. BOX 741715, DALLAS, TX, 75374-1715, US

(73) Assignee: Digital Recorders, Inc., Dallas, TX (US)

(21) Appl. No.: 11/469,777

(22) Filed: Sep. 1, 2006

Related U.S. Application Data
(60) Provisional application No. 60/713,414, filed on Sep. 1, 2005.

(51) Int. Cl. G08B 29/00; G08B 23/00; G08B 13/00

(52) U.S. Cl. 340/506; 340/573.1; 340/574

(57) ABSTRACT

A system and method for providing security to at least one mass transit vehicle is disclosed wherein a memory at the at least one mass transit vehicle is used for storing a plurality of digital images that are provided from at least one camera. Upon detection of an alarm signal at the at least one mass transit vehicle at least a portion of the plurality of digital images are transmitted from the mass transit vehicle to a remote monitoring site responsive to the alarm signal.

### CROSS-REFERENCE TO RELATED APPLICATIONS

This application claims benefit of Provisional U.S. Patent Application No. 60/713,414, filed Sep. 1, 2005, and entitled SECURITY SYSTEM FOR URBAN TRANSIT VEHICLES which is incorporated herein by reference.

### TECHNICAL FIELD OF THE INVENTION

This invention relates generally to security systems for mass transit vehicles, and more particularly, to a security system for mass transit vehicles enabling remote real time viewing of activities occurring within a mass transit vehicle and remote shutdown of the mass transit vehicle.

### BACKGROUND OF THE INVENTION

Mass transit vehicles have utilized two-way radio systems for years to facilitate communication between a vehicle operator and a remote location such as a central transit center. More recently, mass transit vehicles have been updated with on-board digital imaging equipment such as video cameras and digital video recorders. The images taken by the video equipment are used for various purposes including quality, safety, and security. However, there is currently no system in place which enables real-time viewing or playback of the video either on-board the vehicle or at a remote location. A vehicle operator experiencing an emergency situation on-board currently has limited means available for relaying the information to transit system management or emergency or law enforcement personnel. Currently, the only means for sending information from the vehicle requires another transit vehicle or law enforcement vehicle to be substantially adjacent to the vehicle.

Recent world events involving terrorist attempts and attacks on mass transit vehicles have increased the need for on-board viewing and remote transmission capabilities of video images recorded on board mass transit vehicles and thereafter remote control of the vehicle in reaction to the images received. Although a mass transit vehicle may be equipped with video imaging equipment, heretofore there has not been any system capable of remotely viewing or handling the data in real time and thereafter communicating back to the vehicle. Additionally, there has been no way to react to events occurring on the mass transit vehicle in real time. A security system for mass transit vehicles which overcomes the foregoing and other difficulties which have long since characterized the prior art is desired.

### SUMMARY OF THE INVENTION

The present invention disclosed and claimed herein, in one aspect thereof, comprises a system and method for providing security to at least one mass transit vehicle. At least one camera generates digital images and is located on the mass transit vehicle. The digital images are stored within a memory for transmission to a remote monitoring site responsive to the generation of an alarm signal. The alarm signal is generated responsive to an input signal from an actuator. A logic unit within the mass transit vehicle retrieves the digital images from the memory and transmits the retrieved digital images to the remote monitoring site responsive to the alarm signal.

### BRIEF DESCRIPTION OF THE DRAWINGS

A more complete understanding of the present invention may be had by reference to the following Detailed Description when taken in connection with the accompanying Drawings, wherein:

FIG. 1 is a block diagram of the operating environment of the security system;

FIG. 2 is a block diagram of the security system;

FIG. 3 is a more detailed block diagram of the security system for mass transit vehicles;

FIGS. 4a-4b are examples of the displays viewed by a remote operator of the security system

FIG. 5 is a flow diagram illustrating a method for restoring throttle control;

FIG. 6 is a flow diagram illustrating a remote alarm actuation;

FIG. 7 is a flowchart illustrating the steps of operation of the security system in accordance with FIG. 8.

FIG. 8 is a diagrammatic view illustrating the operation of the security system;

FIG. 9 is a flow diagram illustrating the process for cancelling an alarm; and

FIG. 10 is a flow diagram illustrating the operation of the force alarm functionality.

### DETAILED DESCRIPTION OF THE INVENTION

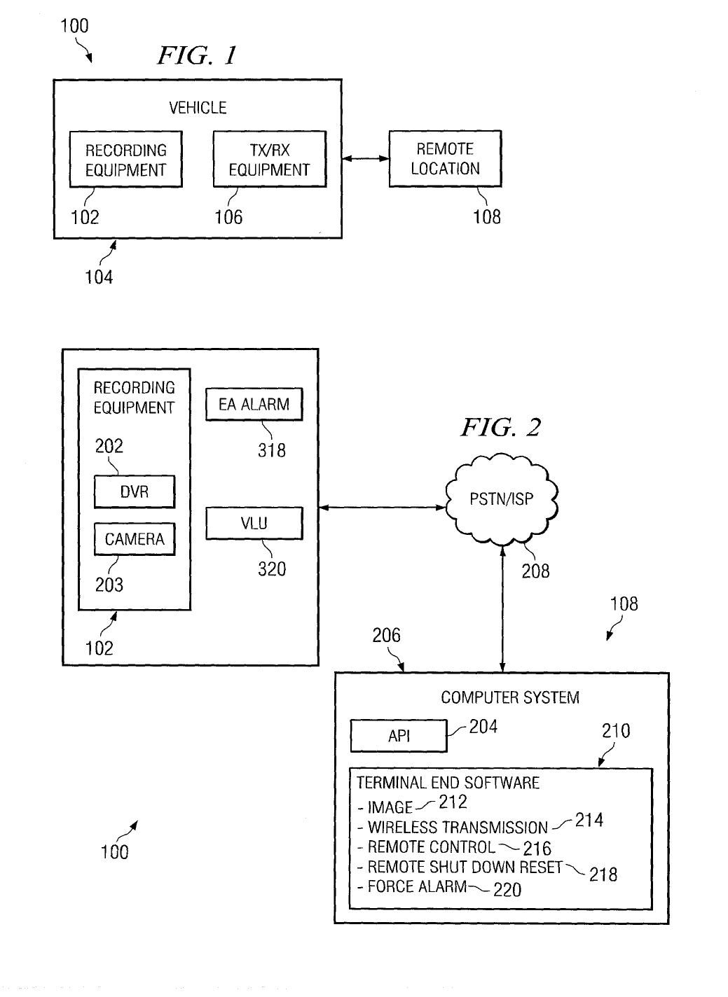

Referring now to the drawings and more particularly to FIG. 1 there is illustrated an operating environment of vehicular security system 100. A vehicular security system 100 includes on board image recording equipment 102 for recording images of events occurring on board a vehicle 104; transmission equipment 106 for real time transmission of the images taken by the on-board image recording equipment 102 to a remote location 108 for viewing, evaluation, and further processing of the images taken on-board; and remote shut off equipment 110 enabling an operator at the remote location 108 to remotely disable the vehicle if necessary.

In accordance with more specific aspects of the invention and referring now more particularly to FIG. 2, a security system 100 for mass transit vehicles comprises on-board image recording equipment 102 including a digital video recorder (DVR) 202 for storing images of events occurring within the vehicle taken by camera 203 which may be an analog or digital camera. If necessary, the vehicle operator (hereinafter referred to as the driver) notifies an operator (hereinafter referred to as a monitor) at a transit terminal center or other specified remote location 108 who thereafter calls the on-board DVR 202 using an Application Program Interface (API) 204 operating on a computer system 206 at the remote location 108. The images from on-board the vehicle are transmitted over a wireless and/or Public Switching Telephone Network (PSTN) 208 back to the transit terminal center 108. The DVR 202 continues to record and store the recorded images while real time or previously stored images are being viewed, i.e., remote viewing or playback of the images does not alter the DVR recording process.

The terminal end software 206 operating on computer system 206 includes a number of functionalities enabling the system to monitor and control activities upon the mass transit vehicle. The image functionality 212 enables an application program interface to interact with the DVR 202 upon the vehicle to obtain images/video and audio over a wireless and/or public switching telephone network that can be viewed through the application program interface 204 at the transit terminal center location 108. The image functionality 212 enables a monitor at the remote location 108 to selectively view any vehicle in the transit network having image capturing and image transmission capabilities for purposes such as quality audits, selective vehicle monitoring, and the like. The images may be video or still images. In addition to the image, an information message is displayed which identifies the vehicle being viewed, the camera providing the view, the date, the time, and other status related information. The image functionality 212 further enables the monitor to toggle between cameras and between recently viewed images and real-time images. The image functionality 212 also enables the monitor to browse through the previously stored images.

The wireless communication functionality 214 provides for control of the wireless communication connection between the vehicle and the transit terminal remote location 108 using transmission equipment 106. Currently available wireless media comprise General Packet Radio Service (GPRS), Digital Cellular Communications, Satellite Communications, and Edge™. However, as will be understood by those skilled in the art, other wireless technologies currently under development will enable faster transmission speeds and enhanced image quality, including but not limited to, Evolution Data Only (EV/DO) protocols and High Speed Data Packet Access (HSPDA). A Public Switching Telephone Network (PSTN) and wireless telecommunications networks used in conjunction with an Internet Service Provider may also be used to facilitate data transmission between the bus 312 and the remote location 108. In the event the signal between the vehicle and the remote location becomes disconnected, the wireless transmission functionality 214 either re-establishes the connection or informs the monitor that connection cannot be re-established, through the API 204.

The remote control functionality 216 enables a monitor at the terminal center remote location to remotely shut down the mass transit vehicle or stop the vehicle from moving or accelerating with an accepted command input sequence. The remote shut down procedure may be initiated by an emergency alarm condition triggered from the bus or responsive to the terminal center monitor deciding from viewed images that a specific transit vehicle needs to be stopped. The remote shutdown reset functionality 218 enables the remote shutdown procedure of the transit vehicle to be disengaged and full control of the bus returned to the driver. The force alarm functionality 220 enables the terminal operator to force the generation of a remote shut down mode on the mass transit vehicle.

Each vehicle is equipped with an emergency (EA) alarm 318. When an EA condition is triggered at the vehicle, the image functionality 212 of the TES software 210 begins displaying images from the subject vehicle after reviewing images from the vehicle. The monitor thereafter views the images and determines what further action is needed, if any. Possible further actions to be taken include alerting law enforcement and emergency personnel, limiting the acceleration or deceleration of the vehicle using the remote control functionality 216, initiating remote shutdown of the vehicle using the remote control functionality 216, etc. If the EA condition warrants shutting the vehicle down remotely, the monitor enters a vehicle shut down command using the remote control functionality 216. The TES software 210 thereafter communicates with a corresponding vehicle logic unit 320 such as DR600™ logic unit available from Digital Recorders, Inc. which relays the shutdown signal to the vehicle. In the preferred practice of the invention, the shutdown signal disables the vehicle's throttle capacity. The vehicle operator is able to maintain navigational control thereby enabling the vehicle operator to guide the vehicle to a safe location even though the throttle is disabled.

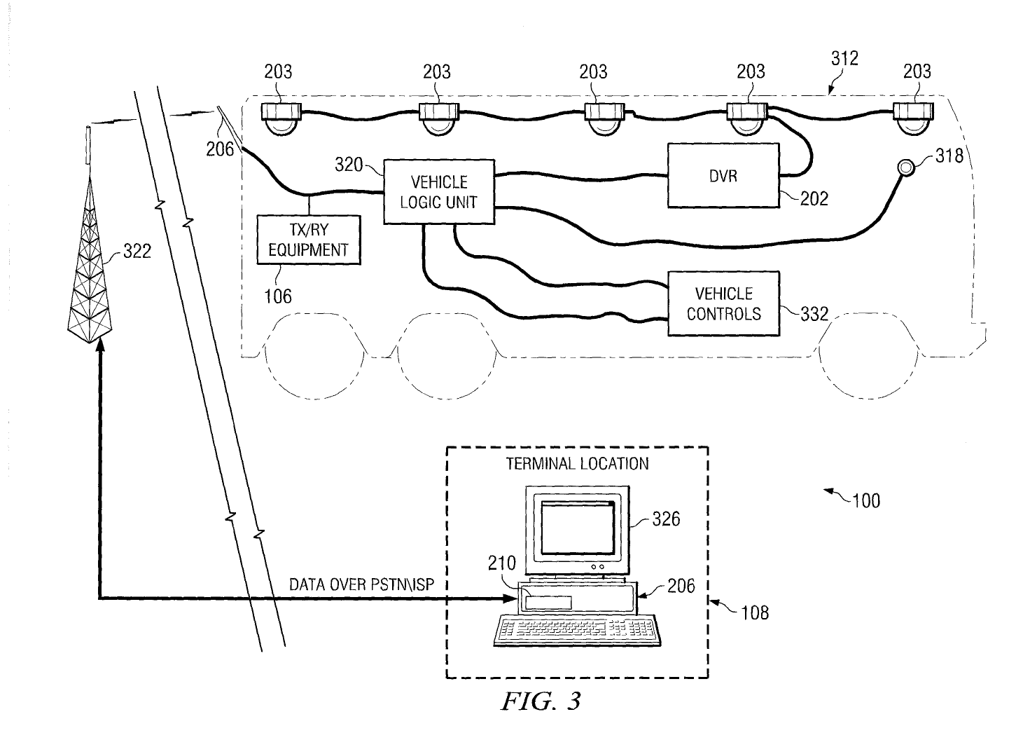

Referring now to FIG. 3, there is shown a more detailed view of the security system 100 for mass transit vehicles comprising the present invention. Although the security system 100 is illustrated in conjunction with a bus, the present invention is applicable to numerous types of mass transit vehicles including light-rail cars, trolleys, and the like. A bus 312 having the security system 100 installed thereon is equipped with cameras 203 which are connected to a digital recording unit 202. The digital recording unit 202 receives the inputs (either video or still images) from the camera 203 and stores the inputs for later transmission to a remote terminal location 108 for viewing and additional handling by a monitor using the transmission equipment 206. The monitor may be human or computerized. A computerized monitor may use video or image recognition software to look for problems in the provided image data and detect emergency conditions without having previously received an emergency condition alarm. The monitor at the remote location 318 can toggle between the views available from the multiple cameras 203 as needed using the image functionality 212.

A vehicle logic unit 320 mounted on the vehicle, such as the DR600™ vehicle logic unit available from Digital Recorders, Inc., transmits data to and from the remote location 108 via wireless communication media using the transmission equipment 106 and signal transmission towers 322. The transmission equipment 106 may use the necessary transmitter/receiver equipment and an antenna to establish a wireless connection with a transmission tower 322. Although the security system is illustrated and described comprising a separate vehicle logic unit 320 and digital video recording unit 202, vehicle logic units are being developed which will incorporate a digital video recorder therein and will thereby negate the need for a separate digital video recorder. The vehicle logic unit 320 may also comprise in control processing circuitry that can perform the operations described herein.

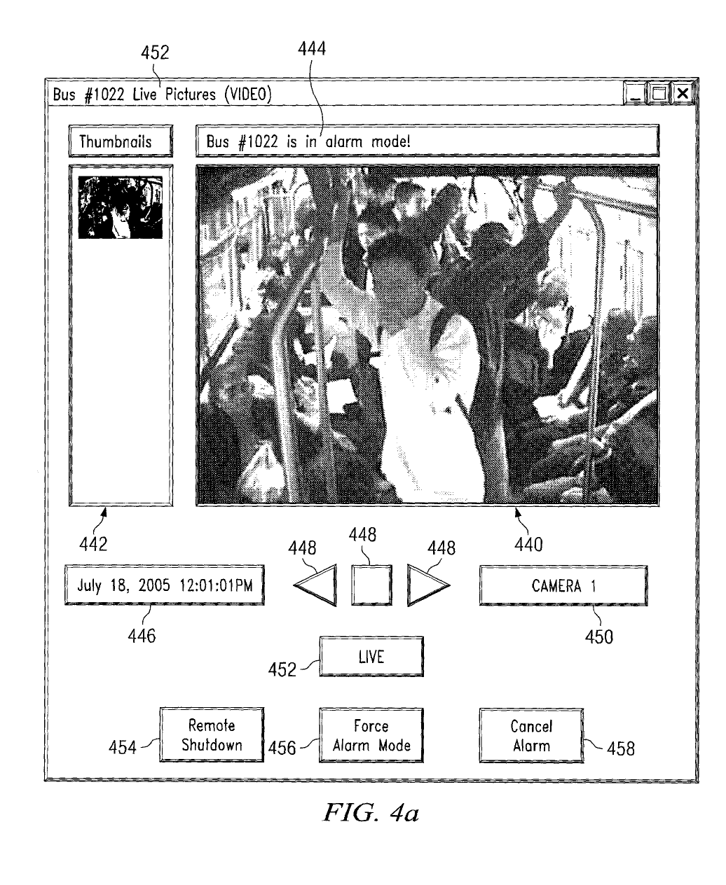

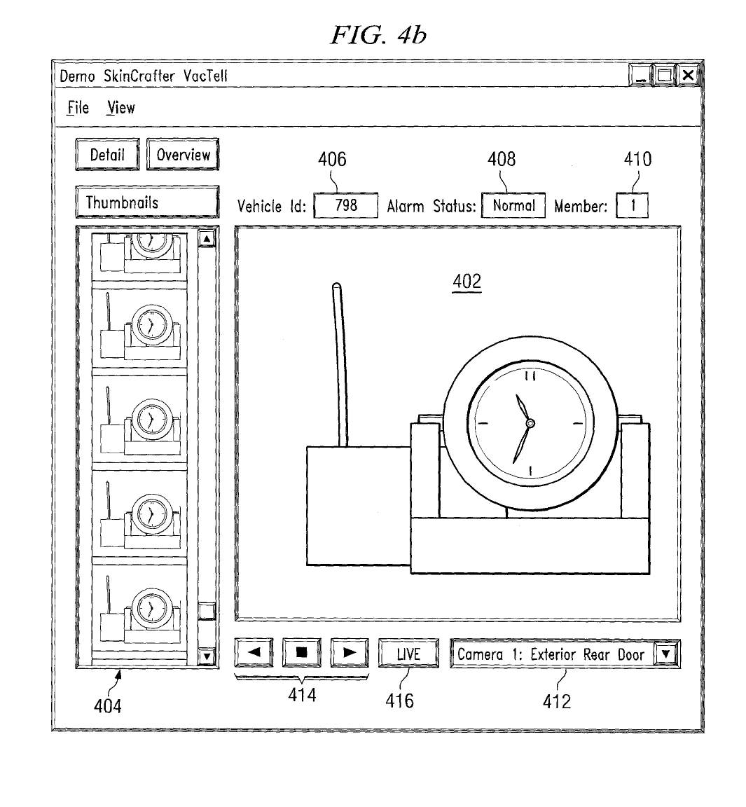

The remote location 108 includes a computer system 206 for receiving data received from the vehicle 312. The computer system 206 comprises at least one display 326 for displaying video and still images from the vehicle 312. The computer system 206 is equipped with Terminal End Software (TES) 210 thereby enabling a monitor at the remote location 108 to selectively view any incoming image data from any vehicle in the transit network. In addition to processing the incoming data, the software 210 enables the monitor to toggle between cameras and between recently viewed images and real-time images, using the image functionality 212. In the event the signal between the vehicle 312 and the remote location 108 becomes disconnected, the wireless transmission functionality 214 of software 28 either re-establishes the connection to the vehicle or displays a message indicating that the connection cannot be re-established. In addition to the video and still images, status information of the image is displayed, including identification the vehicle being viewed, the camera providing the view, the date, the time, and other status related information as illustrated in FIG. 4.

FIG. 4a illustrates the display viewed by the remote monitor at the remote location 108. The display includes a video image 440, a panel showing alternate images available 442, a vehicle identifier 444, date and time information 446, toggle buttons 448, camera identifier 450, video status 452 (live or previously recorded), and control options including remote shutdown 454, remoter operator alarm initiation 456, and cancel alarm 458. FIG. 4b illustrates an alternative embodiment of the display viewed by the remote monitor. This display includes a video image 402 and a series of thumbnails 404 along an edge of the display. Along the top edge of the display is information providing a vehicle ID 406, the present alarm status 408 of the mass transit vehicle being viewed and the number of vehicles viewed by the system at 410. The bottom of the screen provides control buttons for a camera button 412, toggle buttons 414 and a control button 416 to obtain live video feed.

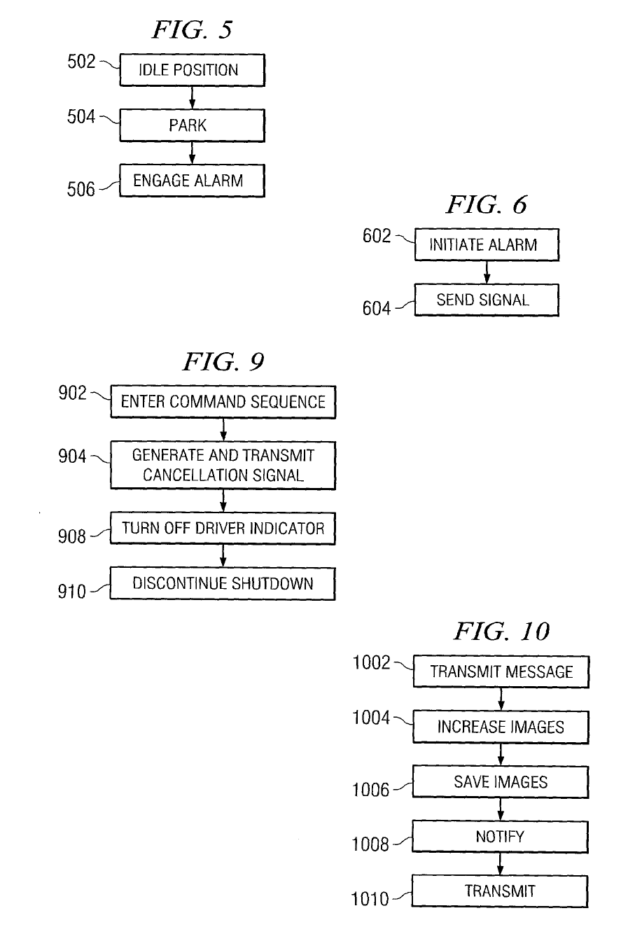

The security system 100 includes additional functions and capabilities as described herein above within the TES software 210 including the ability to restore throttle control to the vehicle after remote shutdown has been initiated and to initiate an alarm condition by the monitor at the remote location 18 without input or knowledge of the driver. Restoring throttle control can be performed either by the driver or by the monitor at the remote location 108. The driver may restore throttle control to the vehicle by practicing a variety of methods, each requiring a specific sequence and timing thereof. Although the steps for restoring throttle control to the driver are predetermined according to individual end-consumer requirements, the following steps illustrated in FIG. 5 comprise a typical sequence of steps for a driver to re-establish throttle control. The driver allows the accelerator pedal to return to an idle throttle position at step 502. The driver next places the vehicle in a “Park” or similar stationary gear at step 504 and engages the alarm button at step 506. The throttle is re-engaged at step 508. The monitor at the remote location 108 restores throttle control to the vehicle by cancelling the emergency alarm condition and returning throttle control.

The monitor at the remote location 108 may also initiate an alarm condition from the remote location without input or knowledge of the driver. If review of the images received from the vehicle indicates that an emergency condition exists and either the driver is unaware or unable to react, the monitor initiates an alarm condition through the computer system 206 at the remote location 108. This process is more fully disclosed in FIG. 6. Once an alarm condition is initiated by the monitor at step 602, an alarm condition signal is sent at step 604 to the vehicle, as if the alarm was initiated on the vehicle by the driver and the EA is engaged at the vehicle at step 606.

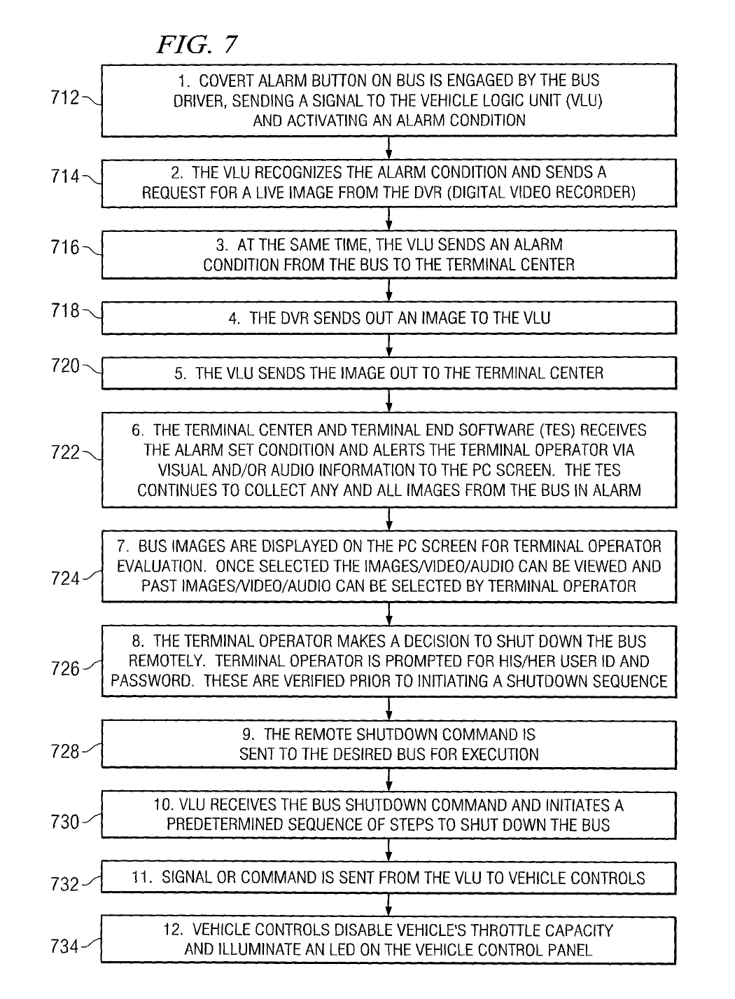

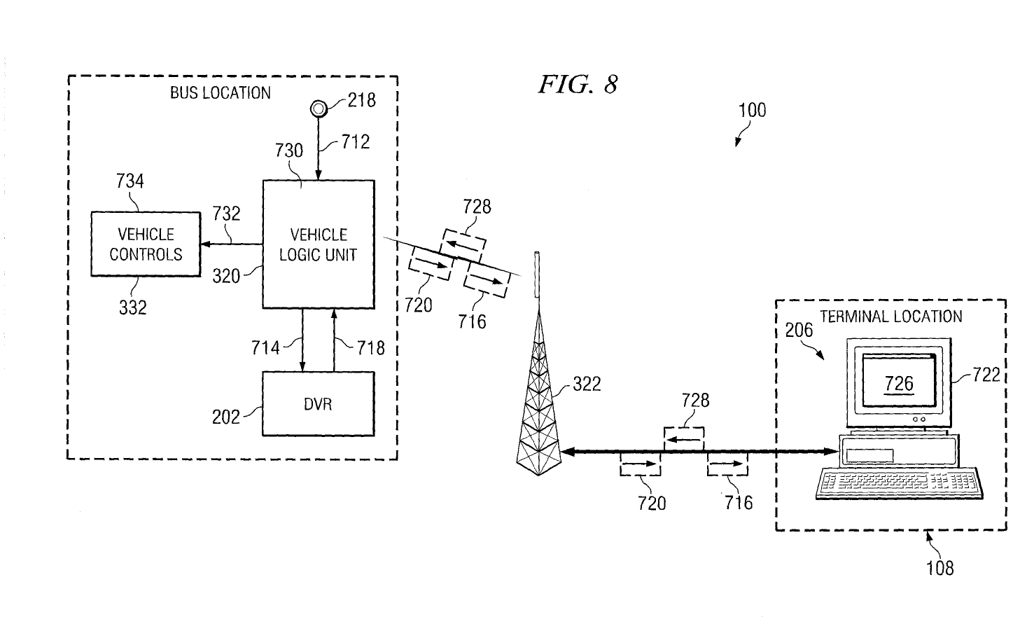

FIGS. 7 and 8 illustrate the operational sequence of the security system 100 in conjunction with a mass transit vehicle such as the bus. The driver engages at step 712 a covert alarm button 318 in the event of a currently occurring or imminent emergency situation on the vehicle thereby initiating an alarm relay. The vehicle logic unit 320 processes the alarm relay and requests at step 714 live images from the digital video recording unit 202 and simultaneously notifies at step 716 the remote location 108 of an alarm condition on the vehicle. The video recording unit 202 sends the video images back to the vehicle logic unit 320 at step 718 which transmits the images to the remote location 108 at step 720. The TES software 210 and the computer system 206 receive at step 722 the data and the alarm condition signal and alerts the monitor. The TES software 210 enables the monitor to select an image for viewing on the display at step 724. The monitor selects images to view for evaluation of the alarm situation. As needed, the monitor toggles between views from the multiple cameras 203 on the vehicle and between real-time and previously recorded images. If the monitor decides that remote vehicle control is needed, the monitor logs into a remote shutdown control sequence at step 726 requiring a predetermined login identification and password which are verified by the system 206. If remote shutdown of the vehicle is required the monitor initiates a remote shutdown command which is sent to the desired bus at step 728. Once the shutdown command is initiated, the vehicle logic unit 320 receives the signal and initiates a predetermined sequence of steps to shut down the vehicle at step 730.

Although the sequence of steps for vehicle shut down can vary according to the configuration of each specific vehicle, the preferred method for shutting down the vehicle comprises sending a signal to the vehicle's controls 332 at step 732 which disables the vehicle's throttle control thereby disabling the driver's ability to activate the accelerator at step 734. A pixel change on the vehicle control panel or other display notification means or a similar defined event that is detectable only by the driver notifies the driver that remote shutdown has been initiated. Although the throttle is disabled, the driver retains control of the remaining operational components of the vehicle including steering and braking. Each vehicle is equipped differently. The IO controls to the transit vehicle may vary depending on the control functionalities associated with the vehicle. Therefore, the method or signal utilized by the vehicle logic unit 320 to initiate shutdown includes but is not limited to relay(s), tie-in points to the vehicle's on-board software, wiring connection between the vehicle logic unit and the vehicle's throttle and electrical system, circuit board controls in the vehicle's electrical system, and other means utilized for disabling a vehicle's throttle system known to those skilled in the art and prevent the vehicle from moving or accelerating.

Alternatively to initiating remote shutdown, the monitor may decide to cancel the emergency alarm condition if the situation has been resolved or the condition was a result of a false alarm as illustrated in FIG. 9. The central terminal monitor may also accomplish a reset of remote shut down procedure by entering an appropriate command sequence within the computer system at step 902. Responsive to the appropriate command sequence, the computer system at the remote monitoring site 108 generates and transmits a cancellation signal at step 904 to the mass transit vehicle. Responsive to the cancellation signal, the vehicle logic unit turns off the driver indicator at step 908. The vehicle logic unit 320 may also issue the appropriate instructions to discontinue the vehicle shut down at step 910.

As shown in FIG. 10, the force alarm functionality 220 is initiated by the monitor by initially transmitting a message at step 1002 to the bus control vehicle logic unit 320 as if the bus driver had pressed the covert alarm button. The control logic in the vehicle initiates the emergency condition at the vehicle at step 1004.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

What is claimed is:

1. A method for providing security to at least one mass transit vehicle, comprising the steps of:
storing a plurality of digital images provided from at least one camera on the at least one mass transit vehicle;
detecting generation of an alarm signal at the at least one mass transit vehicle; and
transmitting at least a portion of the plurality of digital images to a remote monitoring site responsive to the alarm signal

2. The method of claim 1, further including the step receiving control signals at the mass transit vehicle from the remote monitoring site to remotely control operation of the mass transit vehicle.

3. The method of claim 2, further including the step of increasing a rate at which the plurality of digital images are provided from the at least one camera.

4. The method of claim 2, further including the step of shutting down the throttle control of the mass transit vehicle responsive to the control signals.

5. The method of claim 4, further comprising the step of overriding the control signals shutting down the throttle control of the mass transit vehicle responsive to a predetermined input sequence by an operator of the mass transit vehicle.

6. The method of claim 1, wherein the step of storing further comprises the step of storing the plurality of digital images locally at the mass transit vehicle.

7. The method of claim 1, further comprising the step of capturing digital images of the plurality of digital images at a programmably adjustable period of time.

8. The method of claim 1, wherein the step of detecting further comprises the step of generating the alarm signal locally at the mass transit vehicle.

9. The method of claim 1, wherein the step of detecting further comprises the step of generating the alarm signal remotely at the remote monitoring site.

10. The method of claim 1, further including the step of displaying selected digital images of the plurality of digital images at the remote monitoring site responsive to user inputs provided at the remote monitoring site.

11. The method of claim 1, wherein the step of transmitting further comprises the step establishing a wireless connection for transmitting the portion of the plurality of digital images.

12. A security system for use with a mass transit vehicle, comprising:
at least one camera for generating digital images located at the mass transit vehicle;
a digital image recorder for storing the digital images;
an actuator for generating an alarm signal responsive to an input;
a logic unit within the mass transit vehicle for retrieving digital images from the digital image recorder and transmitting the retrieved digital images to a remote monitoring site responsive to the alarm signal.

13. The security system of claim 12, wherein the input for the actuator is provided by an operator of the mass transit vehicle.

14. The security system of claim 12, wherein the input for the actuator is provided by an operator at the remote monitoring site.

15. The security system of claim 12, wherein the logic unit further receives control signals from the remote monitoring site to remotely control operation of the mass transit vehicle.

16. The security system of claim 15, wherein the control signal shuts down the throttle control of the mass transit vehicle.

17. The security system of claim 16 wherein the logic unit overrides the control signals shutting down the throttle control of the mass transit system responsive to a predetermined input sequence by an operator of the mass transit vehicle.

18. The security system of claim 15, wherein the logic unit increases a rate at which the plurality of digital images are provided from the at least one camera responsive to the control signal.

19. The security system of claim 12, wherein the logic unit further establishes a wireless connection for transmitting the portion of the plurality of digital images.

20. The security system of claim 12, further including a monitoring system located at the remote monitoring site for displaying selected digital images of the plurality of digital images at the remote monitoring site responsive to user inputs provided at the remote monitoring site.

21. The security system of claim 20, wherein the monitoring system analyses the digital images to determine if it is necessary to generate the alarm signal.

22. A security system for use with a mass transit vehicle, comprising:
at least one camera for generating digital images located at the mass transit vehicle;
a memory for storing the digital images at the mass transit vehicle;
an actuator for generating an alarm signal responsive to an input;
a logic unit within the mass transit vehicle for retrieving digital images from the memory, transmitting the retrieved digital images to a remote monitoring site responsive to the alarm signal using a wireless connection, and receiving control signals from the remote monitoring site to remotely control operation of the mass transit vehicle.

23. The security system of claim 22, further including a monitoring system located at the remote monitoring site for displaying selected digital images of the plurality of digital images at the remote monitoring site responsive to user inputs provided at the remote monitoring site.

24. The security system of claim 23, wherein the monitoring system analyses the digital images to determine if it is necessary to generate the alarm signal.

25. The security system of claim 22, wherein the logic unit increases a rate at which the plurality of digital images are provided from the at least one camera responsive to the control signal.
